(19) United States
(12) Patent Application Publication
(10) Pub. No.: US 2007/0185631 A1
(43) Pub. Date: Aug. 9, 2007

(54) Multi-functional touchpad controller for automobile

(75) Inventors: I-Hau Yeh, Hsinchu City (TW); Tso-Chieh Yang, Cingshuci Township (TW)

Correspondence Address: TROXELL LAW OFFICE PLLC, SUITE 1404, 5205 LEESBURG PIKE, FALLS CHURCH, VA, 22041, US

(73) Assignee: ELAN MICROELECTRONICS CORP.

(21) Appl. No.: 11/448,847

(22) Filed: Jun. 8, 2006

(30) Foreign Application Priority Data
Feb. 9, 2006 (TW) 095104305

(51) Int. Cl. G06F 17/00

(52) U.S. Cl. 701/36; 701/1

(57) ABSTRACT

A touchpad has a smart man-machine interface. Through a computer system in an automobile, the smart man-machine interface controls systems and multimedia equipments in the automobile, such as an air conditioner and an audio/video player. The interface provides several control modes, such as to control with a keypad, with a writing pad or with a mouse. And the computer system can be connected with a few sets of the touchpad and a display through wire lines or wireless connections.

### FIELD OF THE INVENTION

The present invention relates to a touchpad controller; more particularly, relates to using a smart man-machine interface with a touch pad module to control an automobile computer system, a position navigating system and a multimedia and communication system under a keypad mode, a writing-pad mode and/or a mouse mode.

### DESCRIPTION OF THE RELATED ARTS

A prior art is proclaimed in Taiwan, called “A monitor container fixed in an automobile panel”, where an automobile has a monitor for systems in the automobile. Yet, the monitor can not control them.

Generally, an automobile controls systems mechanically; that is, windows, air conditioner, door locks, and wiper are control led through a mechanical controller. As shown in FIG. 7, a control pad for an air conditioner 91 comprises a knob 92 to control a wind volume, a button 93 to control a wind direction and a sliding bar to switch between a cool wind and a warm wind.

Another prior art is proclaimed in Taiwan, called “A switch system for a multimedia audio/video player and a power supplier in an automobile”, where a switch system 10 comprises an output switch 101, a power supplier 102 , an audio/video interface switching module 103 and a Universal-Serial-Bus (USB) interface switching module 104, where the output switch 101 switches the audio/video in formation the audio/video interface switching module 103 and the USB interface switching module 104 receive to an audio/video system in an automobile; or, a power resource obtained from the automobile is distributed to the power supplier 102. Through rectification and division, the power supplier 102 transforms the distributed power into various currencies and voltages for outputting. The audio/video interface switching module 103 transfers audio/video information to the output switch to be played by the audio/video system in the automobile. The USB interface switching module 104 has at least one USB slot to connect to an external accessory for transferring the audio/video information to the output switch 101 to be played by the audio/video system in the automobile.

Although the above prior arts control multimedia players and systems in the automobile, the life times for the prior arts are limited; and each of the prior arts has a single function, unable in controlling multiple systems in the automobile with a single mechanism. Besides, they are used for controlling multimedia only and are required to connect to multiple multimedia players without an integrated controlling interface connected to an automobile computer and a positioning navigator. Hence, the prior arts do not fulfill users' requests on actual use.

### SUMMARY OF THE INVENTION

The main purpose of the present invention is to provide a touchpad controller having a smart man-machine interface to control an automobile computer system, a position navigating system and a multimedia and communication system under a keypad mode, a writing-pad mode and/or a mouse mode.

To achieve the above purpose, the present invention is a multi-functional touchpad controller for an automobile, comprising a touchpad module, a central controlling module, a response module, an automobile audio/video module, an automobile display module and a remote control module, where the central controlling module has a wireless unit; the remote control module has a wireless output unit; the touchpad module and the remote control module have control modes of a keypad mode, a writing-pad mode and a mouse mode; and a response is displayed by the response module through a sound, a light or an image.

The central controlling module comprises an automobile computer unit, an automobile navigation unit and a multimedia and communication unit controlled by the touchpad module under a keypad mode, a writing-pad mode or a mouse mode. The multimedia and communication unit uses the touchpad module to move a cursor, to control sound volume, to dial a mobile phone, to search, select and/or play multimedia files, and to send a short message or an email.

The touchpad module and the remote control module are used to control the present invention through the central controlling module. The wireless unit in the central controlling module receives AM/FM signals, wireless or digital broadcasting signals, GPS signals, wireless networking signals, mobile communication signals, and digital audio/video signals. The central controlling module further comprises a card reader and an I/O module, where multimedia files in a memory card is read; and a device having an I/O module, such as a computer or a personal digital assistant (PDA), is connected through the I/O module to obtain power and/or to transfer data. Accordingly, a novel multi-functional touch pad controller for an automobile is obtained.

### BRIEF DESCRIPTIONS OF THE DRAWINGS

The present invention will be better understood from the following detailed description(s) of the preferred embodiment(s) according to the present invention, taken in conjunction with the accompanying drawings, in which

FIG. 1 is a structural view of a first preferred embodiment according to the present invention;

FIG. 2A till FIG. 2C are views showing a touchpad module under a keypad mode, a writing-pad mode and a mouse mode;

FIG. 2D and FIG. 2E are structural views showing preferred embodiments of keypads for the touchpad module;

FIG. 3A and FIG. 3B are views showing a remote control module using a touchpad or using a substantial keypad together with a touch pad;

FIG. 4A till FIG. 4C are a structural view and status-of-use views showing statuses of use of the second preferred embodiment;

FIG. 5A and FIG. 5B are views showing statuses of use of a third preferred embodiment;

FIG. 6A and FIG. 6B are views showing statuses of use of a fourth preferred embodiment; and

FIG. 7 and FIG. 8 are views of prior arts.

### DESCRIPTION OF THE PREFERRED EMBODIMENTS

The following descriptions of the preferred embodiments are provided to understand the features and the structures of the present invention.

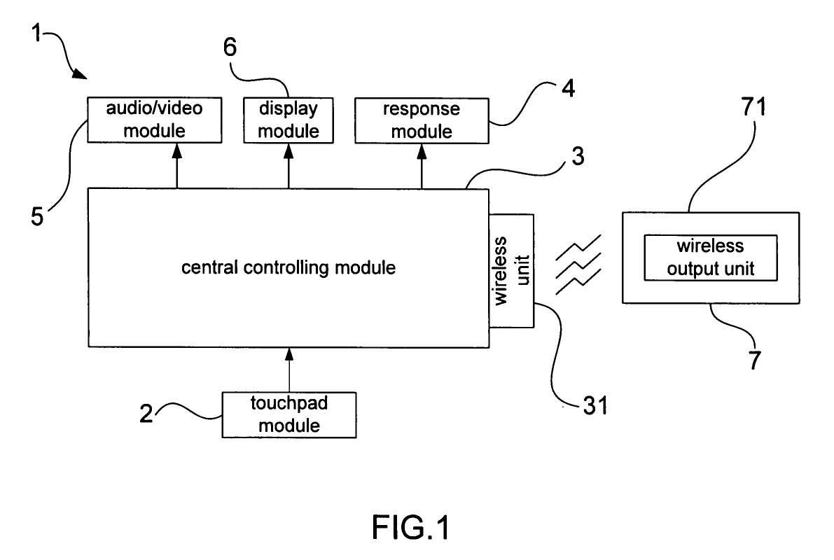

Please refer to FIG. 1, which is a structural view of a first preferred embodiment according to the present invention. As shown in the figure, the present invention is a multi-functional touchpad controller 1 for an automobile, comprising a touchpad module 2; a central controlling module 3 having a wireless unit 31; a response module 4; an automobile audio/video module 5; an automobile display module 6; and a remote control module 7 having a wireless output unit 71.

Therein, the touchpad module 2 with a smart man-machine interface replaces a traditional keyboard or mouse, where the touchpad module 2 has control modes of a keypad mode, a writing-pad mode and a mouse mode and has a mode switch to switch among the control modes. Under the keypad mode, the touchpad module 2 has an area of substantial buttons, or virtual touch buttons instead of the substantial buttons. Under the writing-pad mode, the touchpad module 2 has an area for handwriting recognition to input letters, digits, symbols and figures by handwriting. And, under the mouse mode, the touchpad module 2 has an area for moving a cursor to scroll a scroll bar or to ad just a The remote control module 7 has a touchpad or a substantial keypad together with a touchpad. With the touchpad only, the remote control module 7 has control modes of a keypad mode, a writing-pad mode and a mouse mode. With the substantial keypad together with the touchpad, the remote control module 7 has control modes of a keypad mode, a writing-pad mode and a mouse mode too, just the same as the touchpad module 2. What differs the remote control module 7 from the touchpad module 2 is the ability of the remote control module 7 for a remote control.

The touchpad module 2 and the remote control module 7 sense induction amounts and transform them into signals of coordinates, angular magnitudes or buttons so as to be used in the central controlling module 3. When the central controlling module 3 receives the signals, a light, a sound or an image is notified by the response module 4 that the action is taken. At the same time, audio/video signals are transferred to the automobile audio/video module 5 and the automobile display module 6 to display an image, a sound, a navigation map, a travel mileage, a time information, a vehicle condition, a traffic condition, a fuel consumption condition, an estimated time of arrival, an in-car temperature, an in-car humidity or information from an automobile computer system, where the automobile display module 6 is a flat panel display (FPD).

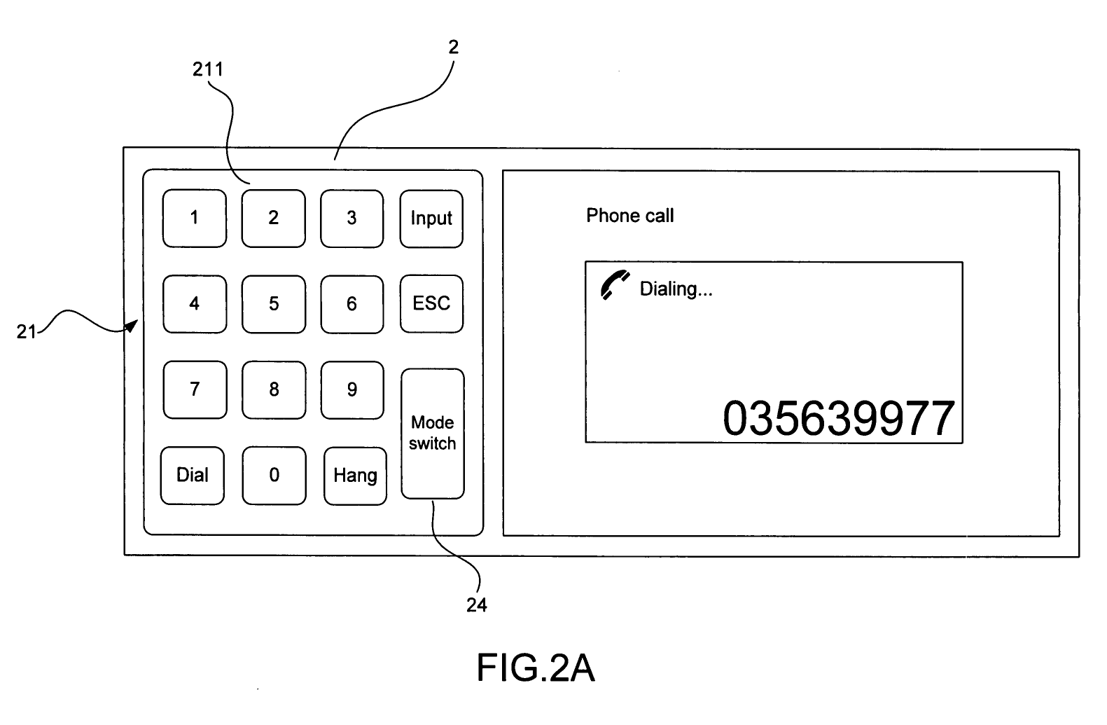

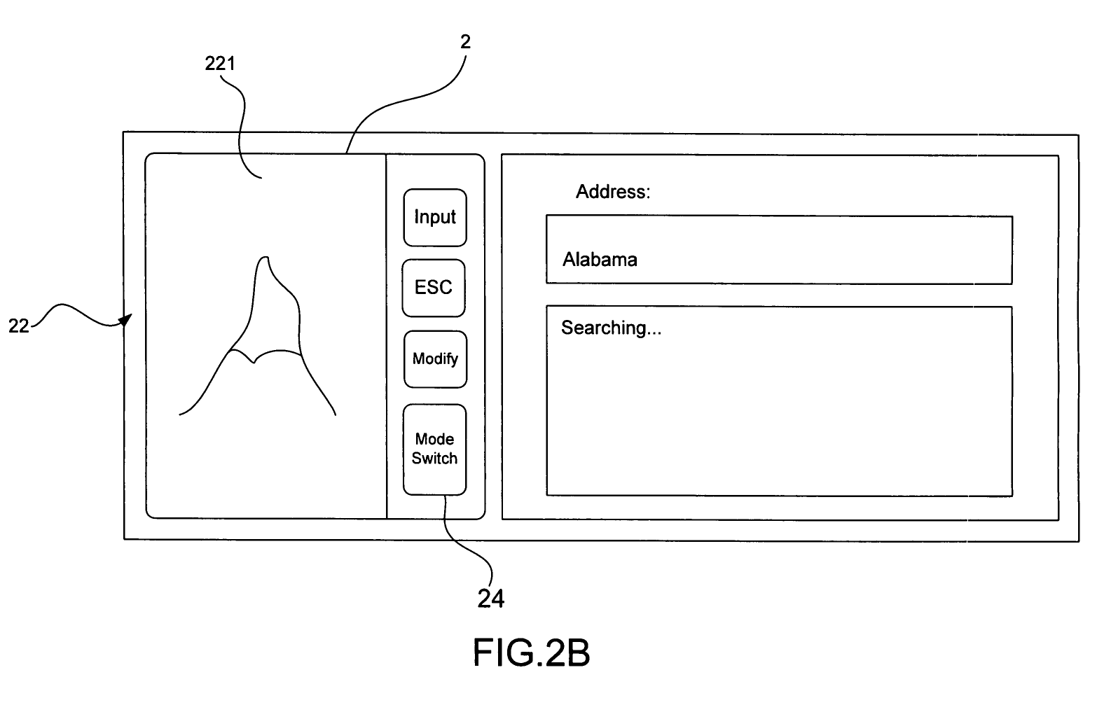

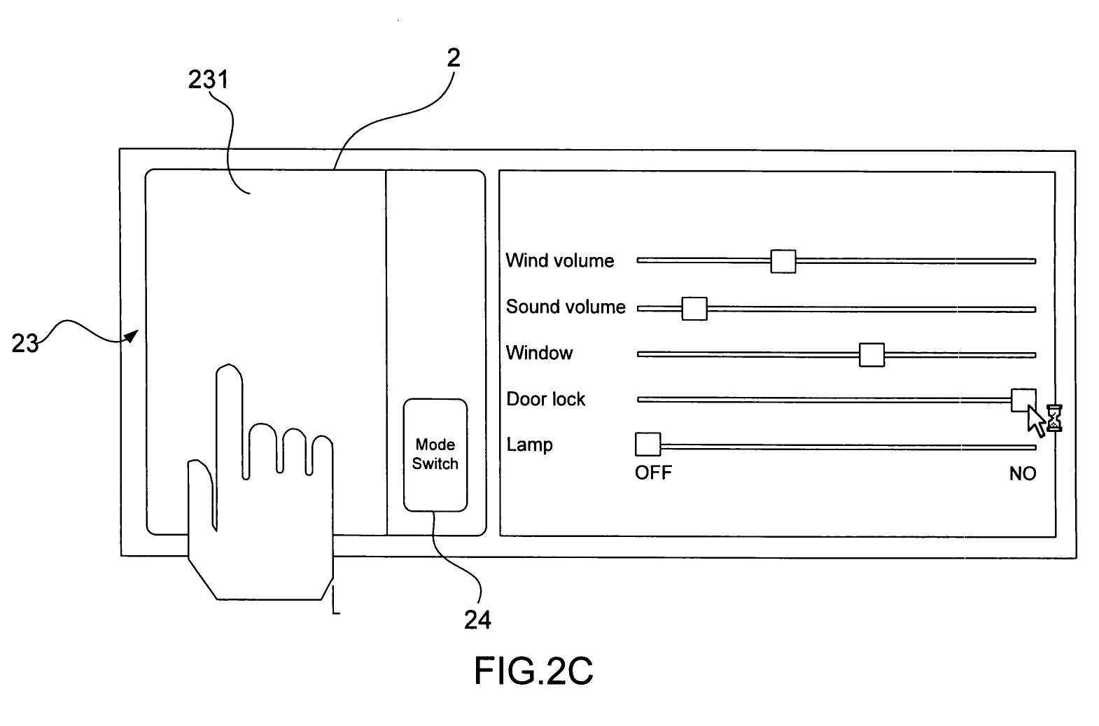

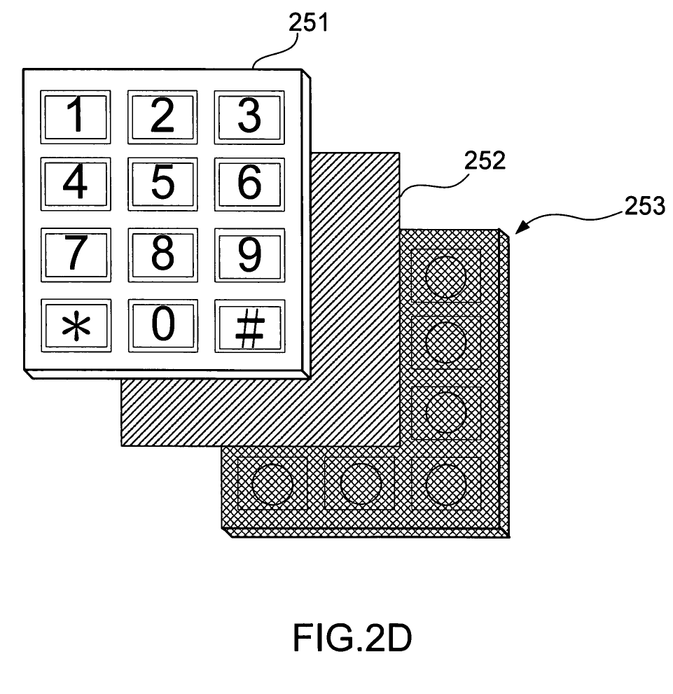

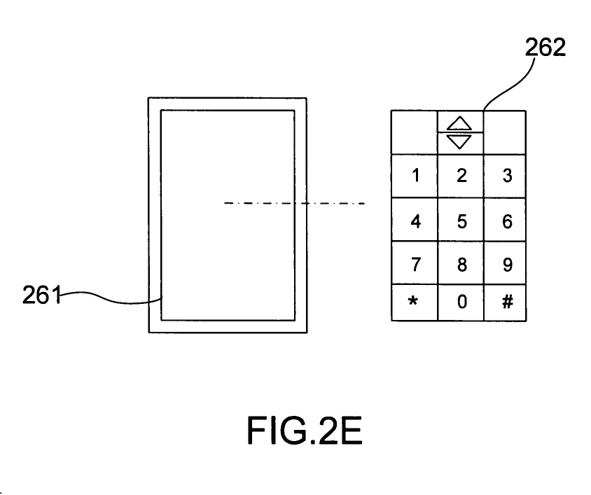

Please refer to FIG. 2A till FIG. 2E, which are views showing a touch pad module under a keypad mode, a writing-pad mode and a mouse mode and structural views showing preferred embodiments of keypads for the touchpad module. As shown in the figures, the control mode for the touchpad module 2 includes a keypad mode 21, a writing-pad mode 22 and a mouse mode 23. The keypad mode 21 uses a substantial keypad or a touchpad. Under the keypad mode 21, the touchpad module 2 has substantial digital keys 211 to enter a telephone number for dialing a phone call; or for selecting a function item by entering the code for the function item. A preferred embodiment for the keypad used in the keypad mode 21 has a structure comprising an insulation layer 251, a film layer 252 and a keypad layer, as shown in FIG. 2D; or, another preferred embodiment for the keypad used in the keypad mode 21 has a structure comprising a touchpad 261 and a keypad layer 262, as shown in FIG. 2E. Under the writing-pad mode 22, the touch pad module 2 has an area 221 for handwriting recognition to input a telephone number or a contact name for dialing a phone call or searching for an address; to label a location or draw a draft map by using a graphic input function and send it through a short message or an email; or, to search or select a multimedia file to be sent. Under the mouse mode 23, the touchpad module has an area for moving a cursor to scroll a scroll bar and to ad just a window for browsing a website or adjusting setups of in-car systems. Furthermore, the touch pad module 2 uses a mode switch 20 to switch among the above modes.

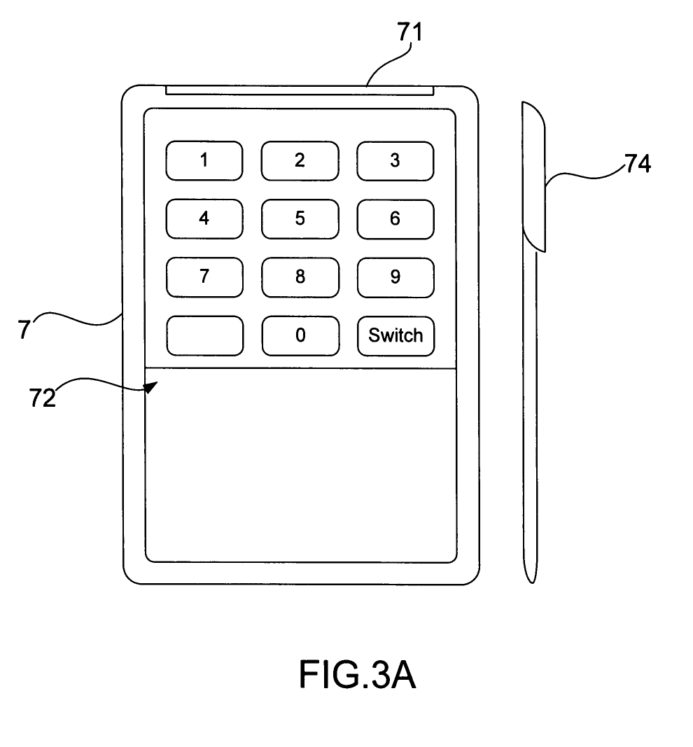

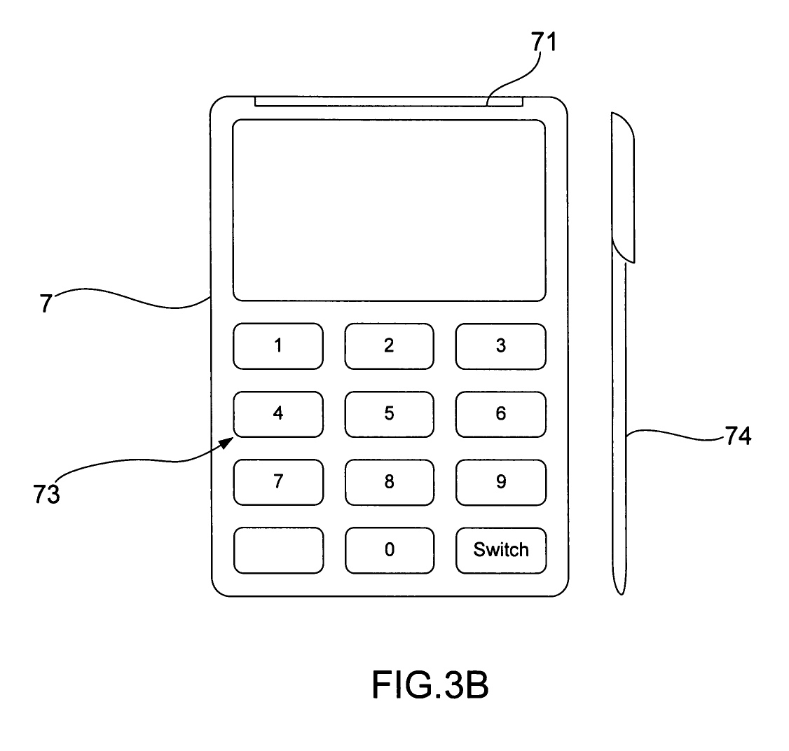

Please refer to FIG. 3A and FIG. 3B, which are views showing a remote control module having a touch pad or a substantial keypad together with a touch pad. As shown in the figures, the remote control module 7 has a touch pad 72 or a substantial keypad together with a touchpad 73. With a touchpad 72, the remote control module 7 has control modes including a keypad mode, a writing-pad mode and a mouse mode. With a substantial keypad together with a touch pad 73, the remote control module 7 has control modes of a keypad mode, a writing-pad mode and a mouse mode, the same as the touchpad module 2. Yet, the remote control module 7 uses a wireless output unit 71 for a remote control. The wireless output unit 71 transmits signals to the central controlling module 3 through a wireless connection of an IrDA (Infrared Data Association) connection, a blue tooth connection, a wireless personal area networking (Zig bee) or a radio connection; and, the signals are received by the wireless unit 31. The remote control module 7 uses a stylus pen 74 or a human finger under the writing-pad mode to input letters, digits, symbols, and figures.

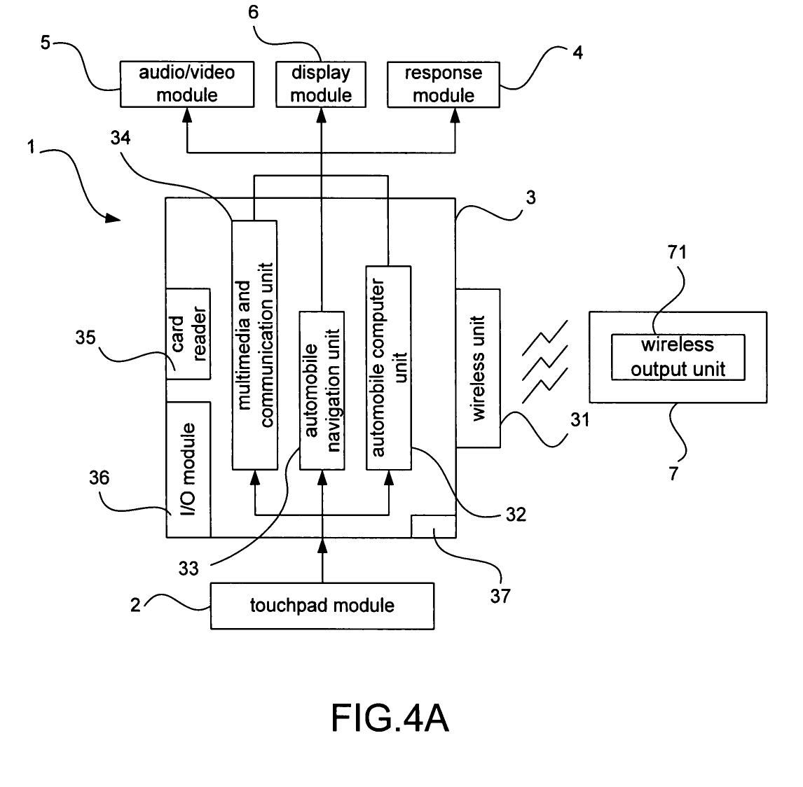

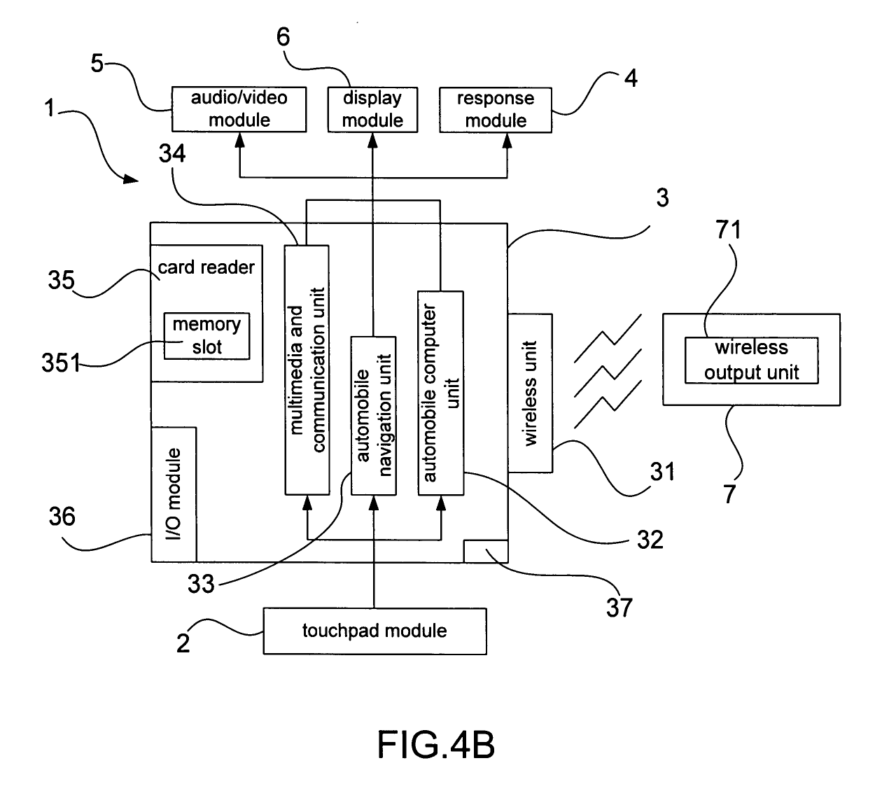

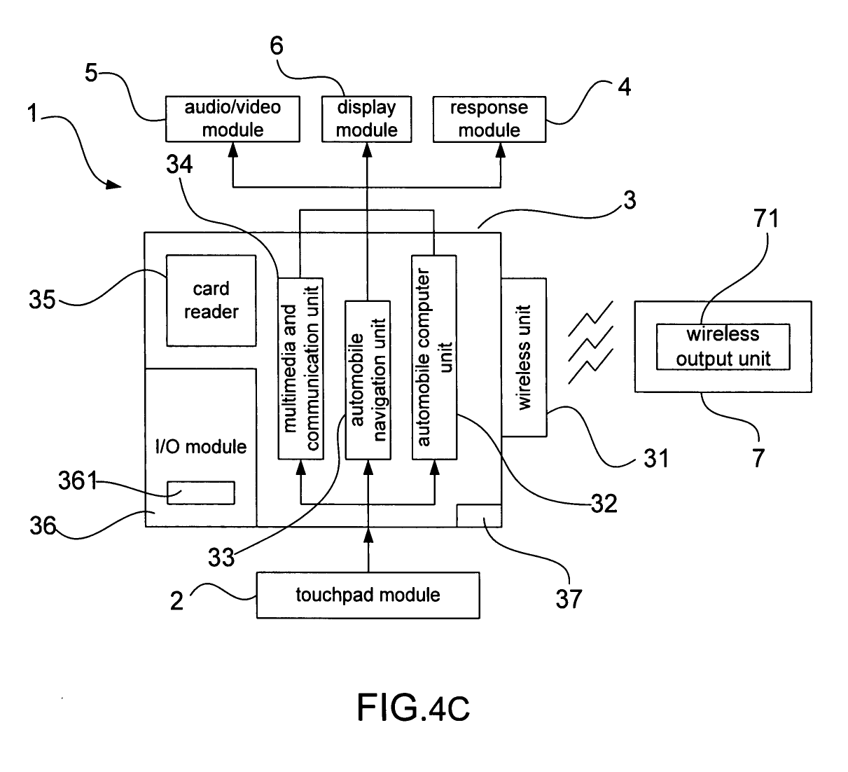

Please refer to FIG. 4A till FIG. 4C, which are a structural view and status-of-use views showing a second preferred embodiment. As shown in the figures, the central controlling module 3 further comprises an automobile computer unit 32, an automobile navigation unit 33 and a multimedia and communication unit 34. The automobile computer unit 32 controls setups of systems in an automobile, such as a window system, an air conditioner system, a door-lock system, an anti-theft system, a lamp system and a wiper system; or, the automobile computer unit 32 shows information of a travel mileage, an average fuel consumption, an estimated time of arrival, etc. at the same time. The automobile navigation unit 33 receives Global Positioning System (GPS) signals from the wireless unit 31 of the central controlling module 3 while the touch pad module 2 controls the setups of the systems. Through the wireless unit 31, the multimedia and communication unit 34 receives AM/FM broadcasting signals, GPS signals, wireless/digital audio/video/multimedia broadcasting (DVB/DAB/DMB) signals; or, the multimedia and communication unit 34 transmits and receives wireless networking (TCP/IP) signals, or mobile communication signals (3G, 4G). Thus, functions are selected through the touch pad module 2 or the remote control module 7, such as selecting a channel, adjusting a sound volume, browsing through windows, dialing a phone call, using a WI FI networking phone, entering a website address, etc.

Besides, the central controlling module 3 further comprises a card reader 35, an input/output (I/O) module 36 and a microphone jack 37, wherein the card reader 35 has a memory slot 351 for various memory card, such as a Secure Digital (SD) card, a multimedia card (MMC) and a reduced size multimedia card (RS-MMC), to read multimedia files in the memory card, such as a photo, an image, a navigation map and a music, to be displayed by the automobile audio/video module 5 and the automobile display module 6.

The I/O interface 361 of the I/O module 36 has a Universal Serial Bus (USB) interface, a high-speed serial bus (1394) interface or a High-Definition Multimedia Interface (HDMI) for connecting to a device having an I/O interface, such as a computer, a personal digital assistant (PDA), a smart phone and a multimedia player (PMP, MP3, etc.). A power is obtained from the central controlling module 3 through the I/O module 36; and, information are transferred to the central controlling module 3 to be displayed by the automobile display module 6. The automobile display module 6 further displays a travel mileage; sets up a travel mileage; and records average fuel consumption s etc.

The microphone jack 37 is plugged with a microphone for in putting a sound by singing a song, or for utilizing a hands-free function of a mobile. Through the central controlling module 3, the sound is transferred to the automobile audio/video module 5; or, communication signals are transferred through the wireless unit 31 of the multimedia and communication unit 34.

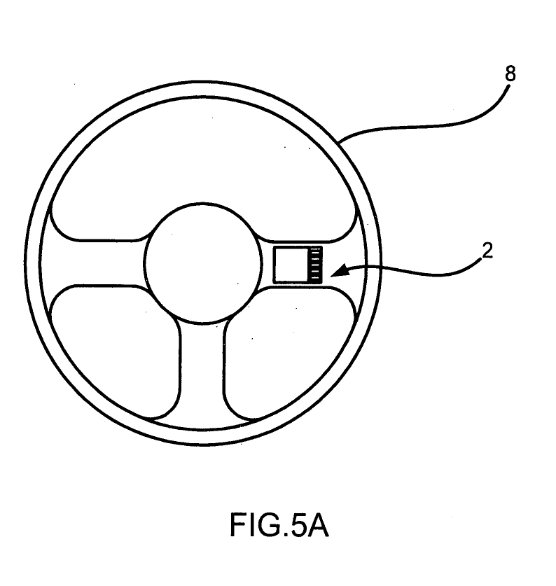

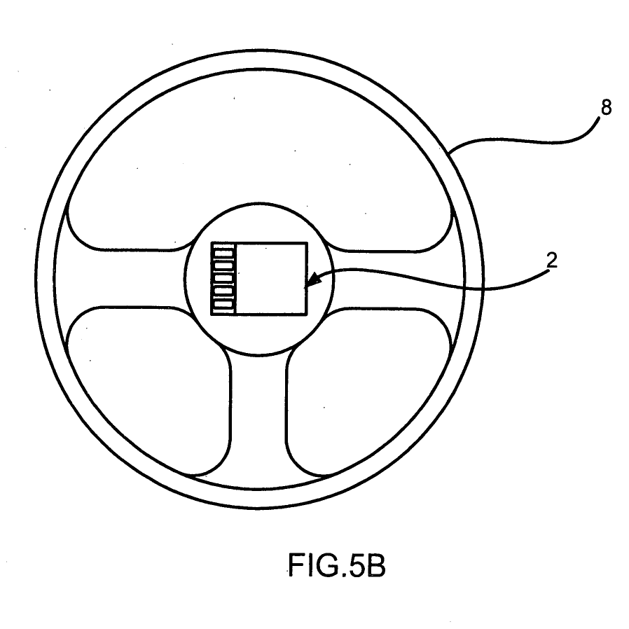

Please refer to FIG. 5A and FIG. 5B, which are views showing statuses of use of a third preferred embodiment. As shown in the figures, the touch pad module 2 is deposed at a side of a steering wheel 8, which turns as the steering wheel 8 turns (as shown in FIG. 5A); or, the touch pad module 2 is deposed at center of the steering wheel 8 (as shown in FIG. 5A). And the touchpad module 2 is connected to the central controlling module 3 through a wire or a wireless connection.

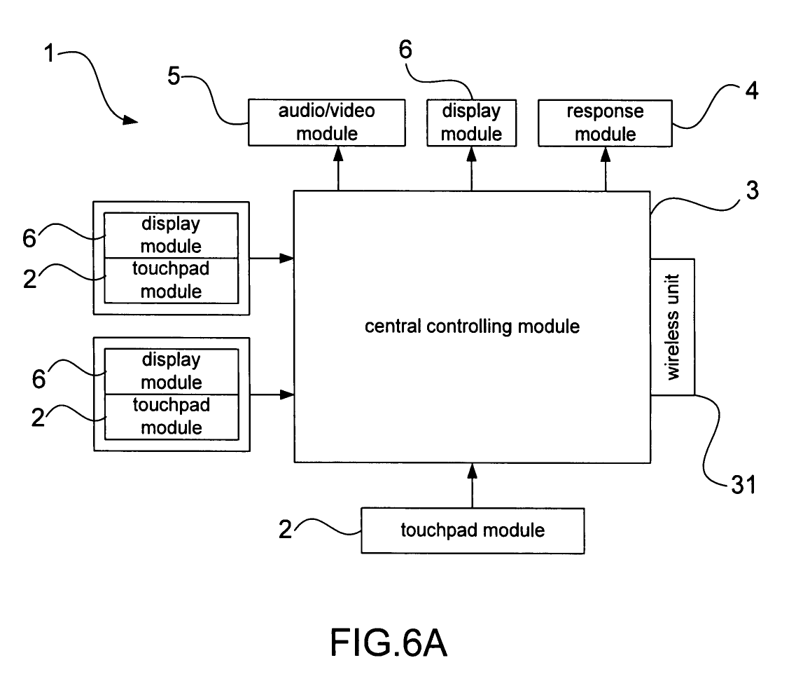

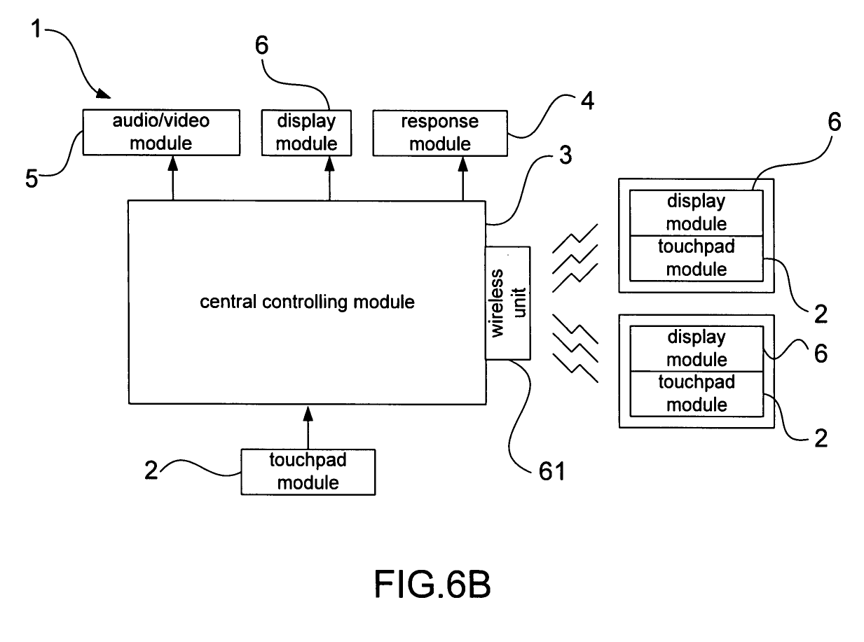

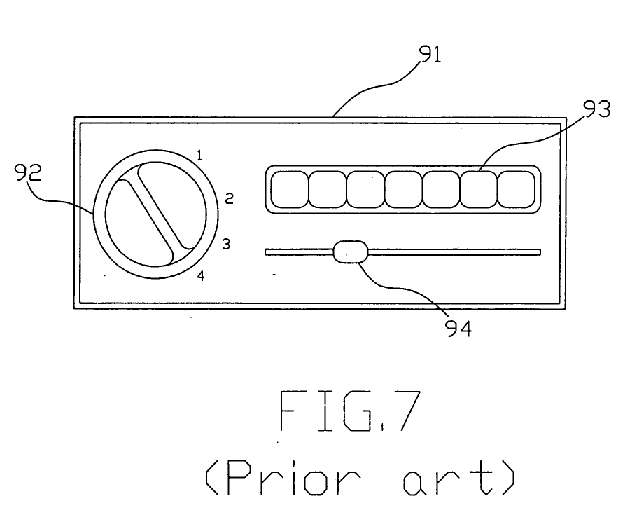

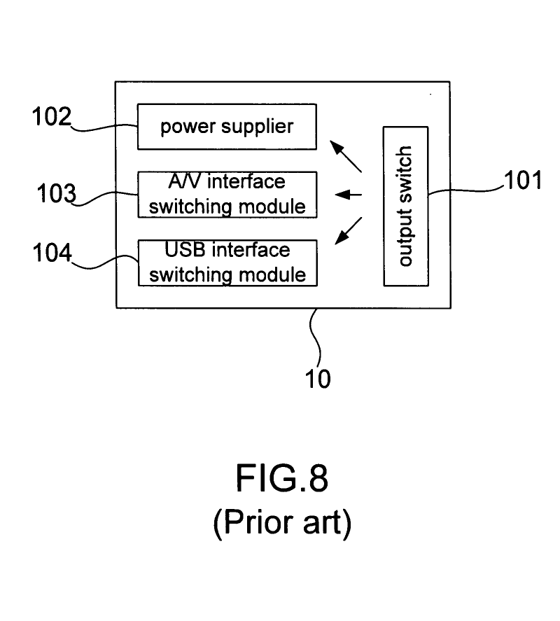

Please refer to FIG. 6A and FIG. 6B, which are views showing statuses of use of a fourth preferred embodiment. As shown in the figures, a touchpad controller 1 has more than one touchpad module 2 and automobile display module 6, set on the back of the front seats or at a proper place in the automobile, for a convenient use by the passengers at the back seats. As shown in FIG. 6A, the touchpad modules 2 and the automobile display modules 6 are connected to the central controlling module 3 through wire line; or, as shown in FIG. 6B, the touchpad modules 2 and the automobile display modules 6 are connected to the central controlling module 3 through a wireless connection. Thus, the passengers easily control systems and a multimedia and communication system in an automobile.

To sum up, the present invention is a multi-functional touch pad controller for an automobile, where the touchpad controller has a longer life time; a touchpad module is operated under various modes for controlling systems in the automobile with a switch for switching among the various modes; and a remote control module is used for a convenient remote control.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A multi-functional touchpad controller for an automobile, comprising:
a touchpad module, said touchpad module being an input device for an automobile computer, a positioning navigator, and a multimedia and communication system;
an automobile audio/video module, said automobile audio/video module processing audio/video signals;
a first automobile display module, said first automobile display module displaying image, navigation map and information from said automobile computer;
a remote control module, said remote control module having a wireless output unit to control said touchpad controller remotely;
a response module, said response module showing a response through a signal selected from a group consisting of a sound signal, an optical signal and an image signal; and
a central controlling module, said central controlling module having a wireless unit to receive signals from a device selected from a group consisting of said touchpad module and said remote control module, said central controlling module transferring transformed signals to said first automobile display module and said automobile audio/video module.

2. The touchpad controller according to claim 1,
wherein said central controlling module further comprises an automobile computer unit, a automobile navigation unit, and a multimedia and communication unit; and
wherein said automobile computer unit sets up in-car systems in said automobile.

3. The touchpad controller according to claim 2,
where in said in-car system includes at least a device selected from a group consisting of a window system, an air conditioner system, a door-lock system, an anti-theft system, a lamp system and a wiper system.

4. The touch pad controller according to claim 1,
wherein said central controlling module further comprises a card reader, an input/output (I/O) module and a microphone jack.

5. The touch pad controller according to claim 4,
wherein said card reader reads a card selected from a group consisting of an secure digital (SD) card, a multimedia card (MMC) and an reduced size multimedia card (RS-MMC).

6. The touch pad controller according to claim 4,
wherein said I/O module has an I/O interface selected from a group consisting of a universal serial bus (USB) interface, a high-speed serial bus (1394) interface and a high-definition multimedia interface (HDMI).

7. The touch pad controller according to claim 4,
wherein said I/O module is connected with a device having an I/O interface and
wherein said I/O interface is selected from a group consisting of a USB interface, a 1394 interface and an HDMI interface.

8. The touchpad controller according to claim 7,
wherein said device is selected from a group consisting of a computer, a personal digital assistant (PDA), a multimedia player and a smart phone.

9. The touchpad controller according to claim 1,
where in said first automobile display module is a flat panel display (FPD).

10. The touchpad controller according to claim 1,
wherein said touchpad module is operated under a mode selected from a group consisting of a keypad mode, a writing-pad mode and a mouse mode.

11. The touch pad controller according to claim 1,
wherein said remote control module is operated under an input mode selected from a group consisting of a keypad mode, a writing-pad mode and a mouse mode.

12. The touchpad controller according to claim 1,
wherein said central controlling module further comprises at least a second automobile display module, a second remote control module and a second touchpad module.

13. The touchpad controller according to claim 12,
wherein said second automobile display module is connected with said central controlling module through a wireless transmission protocol selected from a group consisting of IrDA (Infrared Data Association) protocol and blue tooth protocol.

14. The touchpad controller according to claim 12,
wherein said second automobile display module is set at a back of a front seat in a car.

15. The touchpad controller according to claim 1,
wherein said wireless unit receives signals transmitted from said wireless output unit of said remote control module.

16. The touchpad controller according to cIaim 15,
wherein said wireless output unit transmits signals through a wireless connection selected from a group consisting of an IrDA connection, a blue tooth connection, a wireless personal area networking (Zigbee) and a radio connection.

17. The touchpad controller according to claim 1,
wherein said wireless unit receives signals selected from a group consisting of AM/FM radio signals and Digital Audio Broadcasting (DAB) signals.

18. The touchpad controller according to claim 1,
wherein said wireless unit receives signals selected from a group consisting of Global Positioning System (GPS) signals, Digital Video Broadcasting (DVB) signals and Digital Audio Broadcast (DMB) signals.

19. The touchpad controller according to claim 1,
wherein said wireless unit transmits and receives signals selected from a group consisting of wireless networking signals and mobile communication signals.

20. The touchpad controller according to claim 1,
wherein said first automobile display module displays information including at least data selected from a travel mileage, a time, a vehicle condition, a traffic condition, a fuel consumption, an estimated time of arrival, an in-car temperature and an in-car humidity.
